(19) United States
(12) Patent Application Publication
(10) Pub. No.: US 2015/0154287 A1
(43) Pub. Date: Jun. 4, 2015

(54) METHOD FOR PROVIDING RECOMMEND INFORMATION FOR MOBILE TERMINAL BROWSER AND SYSTEM USING THE SAME

(71) Applicant: TENCENT TECHNOLOGY (SHENZHEN) COMPANY LIMITED, Shenzhen City, Guangdong (CN)

(72) Inventors: Wenjun Gao, Shenzhen City (CN); Chuanchuan Bo, Shenzhen City (CN)

(21) Appl. No.: 14/414,018

(22) PCT Filed: Jul. 9, 2013
(86) PCT No.: PCT/CN2013/079050

§ 371 Date: Jan. 9, 2015

(30) Foreign Application Priority Data
Jul. 10, 2012 (CN) 201210236618.9

(51) Int. Cl. G06F 17/30

(52) U.S. Cl. CPC G06F 17/30696

(57) ABSTRACT

The present disclosure provides a method and system for providing recommend information for mobile terminal browser. The method includes: a mobile terminal browser classifying each website within a historical website record, calculating a score of each classifier of each website, adding scores of identical classifiers to obtain an addition result of each classifier; the mobile terminal browser ranking the various classifiers according to the addition results; starting from a classifier having a highest score, extracting a set number of classifiers and sending the extracted classifiers to a server; the server generating recommend information associated with the classifiers and sending the generated recommend information to the browser for display. The solution of the present disclosure can provide recommend information to each mobile terminal browser based on the historical website information of user access.

This application claims the benefit of priority from Chinese Patent Application, No. 201210236618.9, filed on Jul. 10, 2012, the entire contents of which are hereby incorporated by reference.

### FIELD OF THE DISCLOSURE

The present disclosure relates to network information technology, and more particularly to, a method and system using the method for providing recommend information for mobile terminal browsers.

### BACKGROUND

An existing method for providing recommend information for mobile terminal browsers specifically includes: clicking, by a user, to open a mobile terminal browser, sending, by the browser, a request to a server, and sending, by the server, pre-generated recommend information to the browser for display.

In the existing method, for any one mobile terminal user, the recommend information issued and returned by the server is the same. In other words, the server sends the same recommend information to all the mobile terminals. But various mobile terminal users have their different needs for the recommend information, thus, the recommend information provided according to the existing method lacks specificity and accuracy, and is difficult to meet diverse needs of various users.

### SUMMARY

According to one aspect of disclosure, a method for providing recommend information for a mobile terminal browser includes:

a mobile terminal browser classifying each website within a historical website record, calculating a score of each classifier of each website, adding scores of identical classifiers to obtain an addition result of each classifier;

the mobile terminal browser ranking the various classifiers according to the addition results; starting from a classifier having a highest score, extracting a set number of classifiers and sending the extracted classifiers to a server;

the server generating recommend information associated with the classifiers and sending the generated recommend information to the browser for display.

According to another aspect of disclosure, a system for providing recommend information for a mobile terminal browser, the system includes a browser and a server;

the browser is configured to classify each website within a historical website record, calculate a score of each classifier of each website, add scores of identical classifiers to obtain an addition result of each classifier; rank the various classifiers according to the addition results; starting from a classifier having a highest score, extract a set number of classifiers and send the extracted classifiers to the server;

the server is configured to receive the classifiers from the browser, generate recommend information associated with the classifiers and send the generated recommend information to the browser for display.

According to another aspect of disclosure, a method for providing recommend information for a mobile terminal browser includes:

analyzing by a mobile terminal browser, a historical website record of websites accessed by a user who uses the mobile terminal browser, to determine the user's preferences;

initiatively reporting, by the mobile terminal browser, the user's preferences to a server;

receiving, by the server, the user's preferences, and generating recommend information based on the user's preferences;

providing, by the server, the recommend information to the browser for display.

According to another aspect of disclosure, a computer-readable storage medium comprising a set of instructions for providing recommend information for a mobile terminal browser is provided; the set of instructions are to direct at least one processor to perform acts of:

classifying, by a mobile terminal browser, each website within a historical website record, calculating a score of each classifier of each website, adding scores of identical classifiers to obtain an addition result of each classifier;

ranking, by the mobile terminal browser, the various classifiers according to the addition results; starting from a classifier having a highest score, extracting a set number of classifiers and sending the extracted classifiers to a server for generation by the server of the recommend information associated with the classifiers;

receiving and displaying the recommend information associated with the classifiers from the server.

Other aspects of the present disclosure can be understood by those skilled in the art in light of the description, the claims, and the drawings of the present disclosure.

### BRIEF DESCRIPTION OF DRAWINGS

FIG. 1 is a schematic flow chart of a method for providing recommend information for a mobile terminal browser according to the present disclosure; and

FIG. 2 is a schematic diagram of a system for providing recommend information for a mobile terminal browser according to the present disclosure.

### DETAILED DESCRIPTION

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

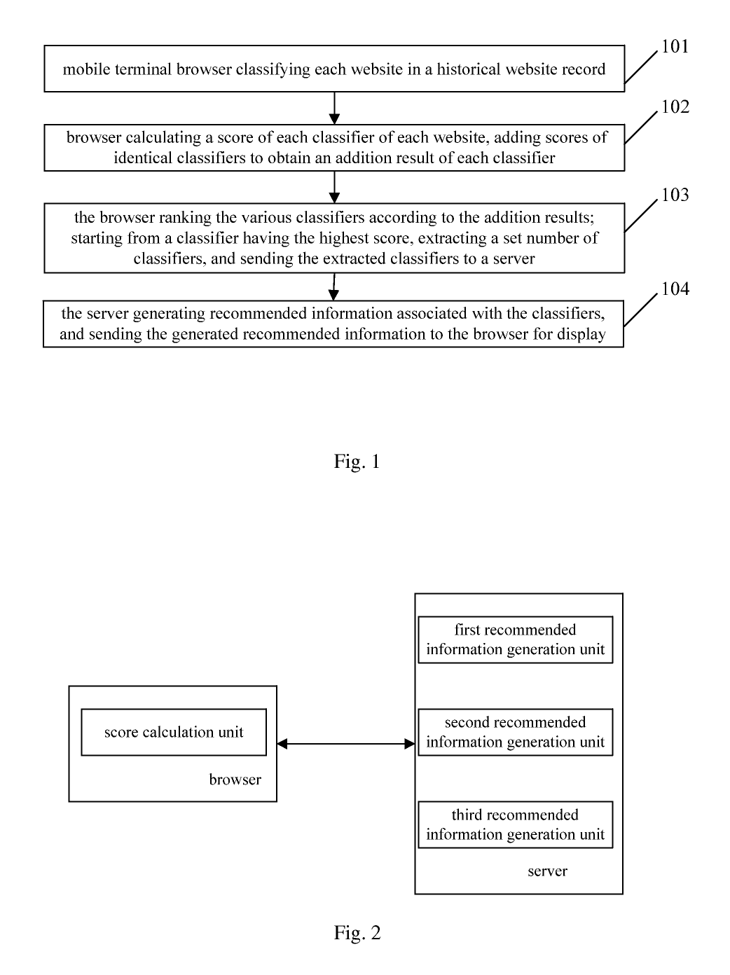

The present disclosure provides recommend information for a mobile terminal browser for various mobile terminals based on historical website information of user access. FIG. 1 is a schematic flow chart of a method for providing recommend information for a mobile terminal browser according to the present disclosure, and the method includes following steps:

Step 101: a mobile terminal browser classifying each website within a historical website record.

The browser caches the historical website record. The historical website record records a user's browsing website historical information including website, website name, access time, etc.

The present disclosure classifies websites according to characteristics of each website. Each website can be classified with at least one classifier. Herein, taking each website having two classifiers including a primary classifier and a secondary classifier as an example for illustration, Table 1 shows rules for classifying websites:

TABLE 1
website classification rules

| Website | Website Name | Classification 1 | Classification 2 |
|---|---|---|---|
| baidu.com | Baidu | search | news |
| taobao.com | Taobao | e-commerce | |
| sina.com | Sina | news | social |
| ifeng.com | Ifeng | news | finance |
| sohu.com | Sohu | news | video |
| youku.com | YOUKU | video | video |
| autohome.com | Autohome | car | |
| soso.com | Soso | search | search |
| tmall.com | Taobao mall | e-commerce | |
| 163.com | NetEase | news | |
| ipad.qq.com | Tencent | news | |
| tudou.com | Tudou | video | |
| app111.com | APP111 | application | game |
| | | recommendation | |
| 360buy.com | Jingdong online | e-commerce | |
| | mall | | |
| qidian.com | Qidian Chinese | read | |
| | novel network | | |
| renren.com | Renren | Social networking | |
| hao123.com | hao123 | navigation | |

Table 1 contains some information of website classification rules. In Table 1, classification 1 refers to a primary classifier and classification 2 refers to a secondary classifier. Some websites each may include a primary classifier and a secondary classifier at the same time, while some websites each may include only a primary classifier with an empty secondary classifier.

After the user clicks to open the mobile terminal browser, the browser reads website information from the cached historical website record. Specifically, according to needs, website information of websites accessed before a set time point can be read, for example, website information of websites accessed in previous days or previous one month. If there are same websites in the read information, one of the same websites is kept. Then, corresponding classifiers can be found out from the table 1 according to the read websites.

Step 102: the browser calculating a score of each classifier of each website, adding scores of identical classifiers to obtain an addition result of each classifier.

One way of calculating the score of each classifier of each website can be set according to actual needs, specifically, for example,

setting a first weight value and a second weight value for a primary classifier and a secondary classifier of each website, respectively;

calculating a click probability score of each website, multiplying the first weight value by the click probability score of each corresponding website to obtain a multiplication result which can be used as a score of the primary classifier; multiplying the second weight value by the click probability score of each corresponding website to obtain a multiplication result which can be used as a score of the secondary classifier.

Assuming: websites which are read from the historical website record and were accessed before the set time point include YOUKU (accessing one time), Tudou (accessing one time), Sohu (accessing one time) and Qidian Chinese novel network (accessing four times), and the first weight value is set to be 5 and the second weight value is set to be 2.5; and times of accessing an identical website before the set time point can be used as a click probability score of this identical website. i.e., the click probability score of each of YOUKU, Tudou and Sohu is 1, and the click probability score of Qidian Chinese novel network is 4, then, scores of the various classifiers obtained through calculation are:
“news” score: 5×1=5;
“video” score: 2.5×1+5×1+2.5×1+5×1=15;
“read” score: 5×4=20.

Wherein, the score of “read” is the highest, the score of “video” is medium, and the score of “news” is the lowest.

Step 103: the browser ranking the various classifiers according to the addition results; starting from a classifier having the highest score, extracting a set number of classifiers, and sending the extracted classifiers to a server.

Based on the example recorded in the step 102, if the set number is 2, then the extracted classifiers include “read” and “video”.

Step 104: the server generating recommend information associated with the classifiers, and sending the generated recommend information to the browser for display.

After the server receives the classifiers, the recommend information associated with the classifiers can be generated through a plurality of manners which are illustrated with examples as the below.

One manner can be of:

Obtaining corresponding websites according to the received classifiers, generating website navigation information according to the obtained websites, and sending a browser start page containing the website navigation information to the browser for display. One classifier can correspond to a plurality of websites, after the server receives the classifier, the server can select high heat websites from the corresponding websites to generate the website navigation information.

Another manner can be of:

setting an entry for reading content in the browser start page, and sending the browser start page to the browser for display; and

receiving a request for reading content sent from the browser, generating a reading content webpage associated with the received classifiers, and sending the generated reading content webpage to the browser for display.

The entry for reading content set in the browser start page can specifically be a button. When a user clicks the button, the browser sends the request for reading content to the server. After the server receives the request for reading content, the server extracts reading content associated with the received classifiers, generates the reading content webpage and issues the generated reading content webpage to the browser. For example, one classifier can be “entertainment”, the server extracts current popular entertainment information, generates a reading content webpage according to the extracted entertainment information, and issues the generated reading content webpage to the browser for display.

Still another manner can be of:

generating message contents associated with the received classifiers, and embedding the message contents into a webpage which the user accesses, and sending the webpage to the browser for display. The message contents can be specifically embedded into a bottom of the browser start page in the manner of text message. When the user browsers the start page, the user can read the message in the bottom of the start page, here, it is assumed that the message is current popular tourist information. The message content can also be displayed in manner of advertising content with a small pop up window.

The mobile terminal browser can be, for example, a QQ browser (HD version, produced and issued from Tencent co. ltd).

In the present disclosure, through classifying the websites in the historical website record, extracting classifiers with higher scores and generating by the server the recommend information according to the extracted classifiers, providing recommend information to each mobile terminal browser based on historical website information of user access can be achieved, so that the recommend information sent to the mobile terminal browser has more specificity, is more accurate and can meet diverse needs of users.

In the present disclosure, through digging the historical website record of websites accessed by the browser, main behaviors of the user of the browser can be received so as to analyze and determine the user's preferences for website types. According to the main preference of the user of the browser, the server can intelligently match website navigation information, reading content information or message content with the user's preference, and provide the matched information to the browser for display. Further, the browser initiatively reports to the server the user's preferences, i.e., extracted classifiers, obtained after analysis, rather than reporting the original website data to the server, thereby protecting the user's privacy. The server can accurately receive the behaviors of the user based on the classifiers sent by the browser, and can feed back recommend information which the user prefers to the browser, thus, a large degree of optimization experience can be brought for the user.

FIG. 2 is a schematic diagram of a system for providing recommend information for mobile terminal browser according to the present disclosure, and the system includes a browser and a server.

The browser is configured to classify each website within a historical website record, to calculate a score of each classifier of each website, and to add scores of identical classifiers to obtain an addition result of each classifier. In another embodiment, the browser is configured to rank the various classifiers according to the addition results; to start from a classifier having the highest score, and to extract a set number of classifiers and send the extracted classifiers to the server.

The server is configured to receive the classifiers from the browser, generate recommend information associated with the classifiers and send the generated recommend information to the browser for display.

Optionally, classifiers of each website can include a primary classifier and a secondary classifier. The browser includes a score calculation unit configured to set a first weight value and a second weight value for the primary classifier and the secondary classifier of each website, respectively; calculate a click probability score of each website, multiply the first weight value by the click probability score of each corresponding website to obtain a multiplication result which can be used as a score of the primary classifier; multiply the second weight value by the click probability score of each corresponding website to obtain a multiplication result which can be used as a score of the secondary classifier.

Optionally, the server includes a first recommend information generation unit configured to obtain corresponding websites according to the received classifiers, generate website navigation information according to the obtained websites, and send a browser start page containing the website navigation information to the browser for display.

Optionally, the server includes a second recommend information generation unit configured to set an entry for reading content in the browser start page, and send the browser start page to the browser for display; receive a request for reading content sent from the browser, generate a reading content webpage associated with the received classifiers and send the generated reading content webpage to the browser for display.

Optionally, the server includes a third recommend information generation unit configured to generate advertising contents associated with the received classifiers, embed the advertising contents into a webpage which the user accesses, and send the webpage to the browser for display.

The methods, units and system described herein may be implemented by hardware, machine-readable instructions or a combination of hardware and machine-readable instructions. Machine-readable instructions used in the examples disclosed herein may be stored in storage medium readable by at least one or more processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided to store instructions to cause a machine to execute a process as described according to examples herein. Specifically, a system or apparatus having a storage medium that stores machine-readable program codes for implementing functions of any of the above examples and that may cause the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. The program code may be downloaded from a server computer via a communication network.

It should be noted that, alternatively to the program codes being executed by a computer, at least part of the operations performed by the program codes may be implemented by an operation system running in a computer following instructions based on the program codes to implement any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to implement any of the above examples.

The foregoing are only preferred embodiments of the present disclosure, and are not used to limit the present disclosure. Any modification, equivalent replacement, or improvement made without departing from the spirit and principle of the present disclosure should fall within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed systems and methods, the browser classifies each website within a historical website record, calculates a score of each classifier of each website, ranks the various classifiers according to the scores and extracts a set number of classifiers; the server is then generates recommend information associated with the classifiers and sends the generated recommend information to the browser for display. In the present disclosure, through classifying the websites in the historical website record, extracting classifiers with higher scores and generating by the server the recommend information according to the extracted classifiers, thus, providing recommend information to each mobile terminal browser based on the historical website information of user access can be achieved. As such, the recommend information sent to the mobile terminal browser has enough specificity and accuracy to meet diverse needs of various users.

1. A method for providing recommend information for a mobile terminal browser, the method comprising:
classifying, by a mobile terminal browser, each website within a historical website record, calculating a score of each classifier of each website, adding scores of identical classifiers to obtain an addition result of each classifier;
ranking, by the mobile terminal browser, the various classifiers according to the addition results; starting from a classifier having a highest score, extracting a set number of classifiers and sending the extracted classifiers to a server for generation by the server of the recommend information associated with the classifiers;
receiving and displaying the recommend information associated with the classifiers from the server.

2. The method of claim 1, wherein each website includes a primary classifier and a secondary classifier; the calculating a score of each classifier of each website comprises:
setting a first weight value and a second weight value for the primary classifier and the secondary classifier of each website, respectively;
calculating a click probability score of each website, multiplying the first weight value by the click probability score of each corresponding website to obtain a multiplication result which can be used as a score of the primary classifier; multiplying the second weight value by the click probability score of each corresponding website to obtain a multiplication result which can be used as a score of the secondary classifier.

3. The method of claim 1, wherein the generating recommend information associated with the classifiers and sending the generated recommend information to the browser for display comprises:
obtaining corresponding websites according to the received classifiers, generating website navigation information according to the obtained websites, and sending a browser start page containing the website navigation information to the browser for display.

4. The method of claim 1, wherein the generating recommend information associated with the classifiers and sending the generated recommend information to the browser for display comprises:
setting an entry for reading content in a browser start page, and sending the browser start page to the browser for display;
receiving a request for reading content sent from the browser, generating a reading content webpage associated with the received classifiers and sending the generated reading content webpage to the browser for display.

5. The method of claim 1, wherein the generating recommend information associated with the classifiers and sending the generated recommend information to the browser for display comprises:
generating message contents associated with the received classifiers, and embedding the message contents into a webpage which the user accesses, and sending the webpage to the browser for display.

6.-10. (canceled)

11. A method for providing recommend information for a mobile terminal browser, comprising:
analyzing, by a mobile terminal browser, a historical website record of websites accessed by a user who uses the mobile terminal browser, to determine the user's preferences;
initiatively reporting, by the mobile terminal browser, the user's preferences to a server;
receiving, by the server, the user's preferences, and generating recommend information based on the user's preferences;
providing, by the server, the recommend information to the browser for display.

12. The method of claim 11, wherein the generating recommend information based on the user's preferences comprises:
intelligently matching, by the server, website navigation information, reading content information or message content with the user's preference.

13. The method of claim 11, wherein the analyzing by a mobile terminal browser, a historical website record of websites accessed by a user who uses the mobile terminal browser, to determine the user's preferences comprises:
classifying, by the mobile terminal browser, each website in the historical website record, calculating a score of each classifier of each website, adding scores of identical classifiers to obtain an addition result of each classifier;
ranking the various classifiers, by the mobile terminal browser, according to the addition results; starting from a classifier having a highest score, extracting a set number of classifiers and sending the extracted classifiers to the server.

14. The method of claim 13, wherein the generating recommend information based on the user's preferences comprises:
generating the recommend information associated with the extracted classifiers.

15. A computer-readable storage medium comprising a set of instructions for providing recommend information for a mobile terminal browser, the set of instructions to direct at least one processor to perform acts of:
classifying, by a mobile terminal browser, each website within a historical website record, calculating a score of each classifier of each website, adding scores of identical classifiers to obtain an addition result of each classifier;
ranking, by the mobile terminal browser, the various classifiers according to the addition results; starting from a classifier having a highest score, extracting a set number of classifiers and sending the extracted classifiers to a server for generation by the server of the recommend information associated with the classifiers;
receiving and displaying the recommend information associated with the classifiers from the server.

16. The computer-readable storage medium of claim 15, wherein each website includes a primary classifier and a secondary classifier; the calculating a score of each classifier of each website comprises:
setting a first weight value and a second weight value for the primary classifier and the secondary classifier of each website, respectively;
calculating a click probability score of each website, multiplying the first weight value by the click probability score of each corresponding website to obtain a multiplication result which can be used as a score of the primary classifier; multiplying the second weight value by the click probability score of each corresponding website to obtain a multiplication result which can be used as a score of the secondary classifier.

17. The computer-readable storage medium of claim 15, wherein the generating recommend information associated with the classifiers and sending the generated recommend information to the browser for display comprises:
obtaining corresponding websites according to the received classifiers, generating website navigation information according to the obtained websites, and sending a browser start page containing the website navigation information to the browser for display.

18. The computer-readable storage medium of claim 15, wherein the generating recommend information associated with the classifiers and sending the generated recommend information to the browser for display comprises:
setting an entry for reading content in a browser start page, and sending the browser start page to the browser for display;
receiving a request for reading content sent from the browser, generating a reading content webpage associated with the received classifiers and sending the generated reading content webpage to the browser for display.

19. The computer-readable storage medium of claim 15, wherein the generating recommend information associated with the classifiers and sending the generated recommend information to the browser for display comprises:
generating message contents associated with the received classifiers, and embedding the message contents into a webpage which the user accesses, and sending the webpage to the browser for display.
